(19) United States
(12) Patent Application Publication
(10) Pub. No.: US 2008/0313562 A1
(43) Pub. Date: Dec. 18, 2008

(54) System and Method for Designing Landscape Architecture Based on Real Image

(76) Inventor: Moon-Jeong Kim, Seongbok-dong (KR)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/916,308

(22) PCT Filed: Jun. 27, 2006
(86) PCT No.: PCT/KR06/02474

§ 371 Date: Jul. 14, 2008

(30) Foreign Application Priority Data
Jul. 1, 2005 (KR) 10-2005-0059096

(51) Int. Cl. G06F 3/048; G06T 15/00; G06F 19/00; G06F 5/00

(52) U.S. Cl. 715/810; 345/419; 707/104.1; 345/629; 707/E17.019

(57) ABSTRACT

For an easy and efficient designing of landscape architecture, disclosed is a system for designing landscape architecture based on real images, which includes: a user interface supporting an exchange of information between the user and the system; a database storing real images obtained by processing photographs of landscape architectural elements; an input processing unit that processes data to display a plan view according to a set-up environment of a landscape site entered through the user interface, and processing data to arrange on the plan view real images of landscape architectural elements, which are selected through a library window provided based on the database; and a display processing unit loading real images from the database based on information about the landscape architectural elements arranged on the plan view according to the user's selected locations entered through the user interface, and displaying the real images.

### TECHNICAL FIELD

The present invention relates generally to a system and method for designing landscape architecture, more specifically, to a system and method for designing landscape architecture based on real images.

### BACKGROUND ART

Landscape architecture is the art and planning of the land and the design of beautiful constructs in consideration of natural and social conditions of the surrounding environment. Landscape designing includes activities such as the investigation and analysis of landscaping elements of landscape architectural sites and preparation of a landscape architecture drawing that best fits a client's demands. Here, landscaping elements refer to landscape-related plants and other facilities needed for landscaping.

Landscaping in general consists of basic planning, basic designing and practical designing. The basic planning is a step for establishing a plan regarding what to arrange in a target space. The environment and situation around the target space are investigated to formulate a basic plan.

The basic designing is a step for developing the basic plan through professional examination. In basic planning, a developing program is established, size of the landscape setting is set up and distributed, and types, quantities and arrangement of landscape elements are planned. On the other hand, in the basic designing stage, spatial constitution and production, and structures, construction and materials of objects are selected.

Practical designing is a step for specifying, by means of drawing and other methods, structures, materials, construction, sizes, quantities, and procedures for actually starting work based on the basic designing, prepared in advance. At this time, the drawing should be drawn according to scale so that an operator can place objects at accurate positions in relation to existing marks and facilities.

The result of practical designing includes a specification or statement recorded of itemized lists including a design drawing, calculation of quantity, unit cost of each material, etc. As a result, the landscape work in a given space can go smoothly.

Traditionally, such work was primarily performed manually by landscape architects based on the functions and purposes of landscaping and clients demands. However, recent advances in computer technologies and programs have granted landscape architects a convenient alternative. For instance, AutoCAD and PhotoShop, separate design programs, can now be used in combination. An AutoCAD drawing image can be converted through effect and filter functions of PhotoShop to create a 3D look and natural texture for landscape architecture.

However, the conventional landscape architecture designing process using a computer requires experienced design professions, and objects in the design are expressed with symbols only, thereby making it very difficult for nonprofessionals to understand those symbols.

In addition, although a detail drawing can be prepared with a 2D CAD program, a 3D virtual actuality drawing has to be prepared with a 3D rendering program. This need for separate tools means that the initial work and subsequent revisions require a substantial amount of effort, and it is not easy to create a realistic 3D design.

Moreover, the conventional landscape architecture design using a computer has a limitation in that a user cannot check the changes in landscape architectural elements in a seasonal environment.

### DISCLOSURE OF INVENTION

### Technical Problem

It is, therefore, an object of the present invention to provide a system and method for designing landscape architecture based on real images, so that even nonprofessionals can easily design landscape architecture.

It is another object of the present invention to provide a system and method for designing landscape architecture based on real images, which provide information on budget estimates for designing the landscape architecture and executing the landscape project, and follow-up and management of constructed landscape architectural components.

### Technical Solution

To achieve the above objects and advantages, there is provided a system for designing landscape architecture based on real images, including: a user interface supporting an exchange of information between a user and the system; a database storing real images obtained by processing photographs of landscape architectural elements; an input processing unit processing data to display a plan view according to a set-up environment of a landscape site entered through the user interface, and processing data to arrange on the plan view real images of landscape architectural elements, which are selected through a library window provided based on the database; and a display processing unit loading real images from the database based on information about the landscape architectural elements arranged on the plan view according to the user's selected locations entered through the user interface, and displaying the real images.

The database stores real images of the landscape architectural elements photographed in diverse angles and directions, and the display processing unit includes a photographing location processing section which loads from the database real images of the landscape architectural elements in correspondence to the user's selected direction and angle entered through the user interface and which displays the real images.

In addition, the database stores images of the respective landscape plants photographed by the unit of a predetermined period, and the display processing unit includes a photographing date processing section which replaces the landscape architectural elements with real images photographed on the user's selected photographing period entered through the user interface and which displays the real images.

In addition, the user interface provides a menu comprising a photographing period of the landscape plants that are subdivided into, at minimum, days, weeks, months, and seasons. Also, the display processing unit includes a photographing period processing section which displays real images photographed during the user's selected photographing period entered through the user interface.

The input processing unit includes: a location storage containing information about locations of landscape architectural elements arranged in the landscape site; and a scale processing component that scales down the landscape architectural elements arranged on the plan view to the scale on the landscape site display.

The library window includes search engines through which the landscape architectural elements are searched from the database according to the categories dictated by the attributes of the landscape architectural elements, and then the landscape architectural elements corresponding to the user's selected category are selectively listed.

Another aspect of the present invention provides a database for use in a system for designing landscape architecture based on computer-readable real images, in which the database stores real images of landscape architectural element photographs without a background, and one or more relevant pieces of information, such as names, attributes, management methods and prices of the respective landscape architectural elements.

Still another aspect of the present invention provides a method for designing landscape architecture based on real images, the method including the steps of: displaying through a user interface a plan view of a set-up environment of a landscape site; processing data to arrange on the plan view real images of user's selected landscape architectural elements entered through the interface, the landscape architectural elements being selected in a library provided based on a database storing real images, which are obtained by processing photographs of the landscape architectural elements; and after the user selects photographing locations through the user interface, displaying real images photographed at the user's selected locations in the database of the respective landscape architectural elements arranged on the plan view according to the user's selected locations entered through the user interface.

The database stores real images of the landscape architectural elements photographed by the unit of a predetermined period, and the method further includes this step: after a user selects a photographing period through the user interface, displaying real images that are photographed at the user's selected period in the database of the respective landscape architectural elements arranged on the plan view according to the user's selected photographing period entered through the user interface.

The user interface provides a menu comprising a photographing period being subdivided into at least one of days, weeks, months, and seasons, and the method further includes the step of: sequentially displaying real images photographed during the user's selected photographing period entered through the user interface.

The database stores real images of the landscape architectural elements photographed in diverse angles and directions, and real images of the landscape architectural elements at the user's selected angle and direction entered through the user interface are displayed.

The database stores management instructions for the respective landscape architectural elements, and the management instructions are displayed if a user requests through the user interface to display the management instructions of the respective landscape architectural elements.

The data processing step involves adjusting scales of the landscape architectural elements arranged on the plan view to the scale on the landscape site display.

According to the method, information about a specification is stored in the database, and in response to a command for generating a landscape architecture specification entered through the user interface, the landscape architecture specification is generated based on information about the user's selected landscape architectural elements. Also, according to the method, the information on prices of the respective landscape architectural elements are stored in the database, and in response to a command for generating an estimated budget information entered through the user interface, the estimated budget information is generated based on information about the user's selected landscape architectural elements.

### ADVANTAGEOUS EFFECTS

Therefore, the present invention system and method for designing landscape architecture based on real images enables even non-experts to easily design landscape architecture and benefit from information about estimated budgets for executing landscape projects and information about follow-up and management of constructed landscape architectural components.

### BRIEF DESCRIPTION OF THE DRAWINGS

The above aspects and features of the present invention are demonstrated through the accompanying drawings and the following descriptions of certain embodiments of the present invention:

FIG. 1 is a schematic block diagram showing one embodiment of a system for designing landscape architecture based on real images that the present invention can produce; and

FIG. 2 and FIG. 3 are flow charts describing the operation of the system in FIG. 1.

### BEST MODE FOR CARRYING OUT THE INVENTION

A preferred embodiment of the present invention will be described below with reference to the accompanying drawings. The same components as those of the preferred embodiment are designated by the same reference numerals, and therefore the explanation of those components will be omitted hereafter.

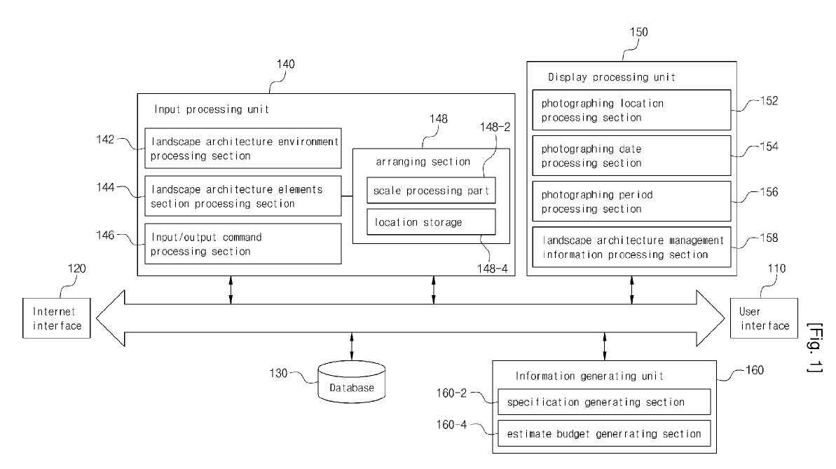

FIG. 1 is a schematic block diagram showing one embodiment of a system for designing landscape architecture based on real images according to the present invention.

As shown in FIG. 1, the system for designing landscape architecture based on real images includes a user interface 110, an Internet interface 120, a database 130, an input processing unit 140, a display processing unit 150 and an information generating unit 160.

The user interface 110 supports the exchange of information between a user and a system. The Internet interface 120 supports the exchange of information between the system and all the servers connected to the Internet. The system may further include an update-processing unit (not shown) for updating the database 130 through the Internet interface 120. The user interface 110 consists of an input device, e.g., a keyboard and a mouse, and a display device, e.g., a monitor, for displaying images.

The database 130 stores real images that are photographed from diverse angles and directions. Therefore, when the user selects a desired angle and direction through the user interface 110, the corresponding real images of the landscape architectural elements are loaded from the database 130 and are displayed together with the information about those landscape architectural elements. It is known that an object located at a downward 27 degrees angle is the most comfortable for human eyes. In consideration of height and distance between a camera and a subject, the main real images are photographed from 15 45 degrees high in the air (an overlooking view) to create a sense of distance and realistic-looking photographs. If desired, however, high-angle shots can be used as real images.

In addition, the database 130 stores information necessary to manage and maintain the respective landscape architectural elements. For instance, names of landscape architectural elements (both in Korean and English, and the scientific/technical name, when applicable), attributes (size, reception, planting and transplant-related information), management methods (preparation for winter, water/fertilizer, prevention of breeding and extermination), prices and the like are displayed with the real images, so that even non-experts can easily understand and manage accordingly.

Also, the database 130 stores different plants growing in different localities. Thus, when the user inputs a location of the landscape architecture site, plants that can be grown in the input location are displayed for the user's convenience.

Moreover, the database 130 stores information about landscape facilities categorized by their applications (e.g., waterscape facilities/resting facilities/amusement facilities/roads, etc.). Landscape plants stored in the database 130 may be categorized not only academically but also by applications. Furthermore, the landscape plants can be categorized by blooming time, colors of flowers, blooming periods, features of fruits and the like.

The information in the database are then processed by the input processing unit 140 and the display processing unit 150, and displayed to the user interface 110.

More specifically, the input processing unit 140 processes data to display a plan view of the environment of the landscape site, set up by the user through the user interface 110. As for the plan view, a high angle image or a real image of a building photographed from the front or side may be stored in the database 130 for later use.

The input processing unit 140 also processes data for landscape architectural elements selected through a library window that is provided on the basis of the database 130 to show on the plan view.

To this end, the input processing unit 140 is comprised of a landscape architecture environment processing section 142, a landscape architectural element selection processing section 144, and an input/output command processing section 146.

The landscape architecture environment processing section 142 suggests an environment set-up engine through which the user is able to set up a desired environment of the landscape architecture. After the user sets up the environment, the landscape architecture environment processing section 142 prepares a landscape site, a plan view of building(s), contour lines, etc. The plan view of the landscape site can easily be obtained through a land/acreage search service on the Internet. Here, the environment set-up engine is a means that allows the user to input all necessary items including location of the landscape site, any legal restrictions, weather conditions, geographical conditions and the like.

Next, the landscape architectural element selection processing section 144 is connected to an arrangement section 148 to process the user's selection of landscape architectural elements through the library window. The arrangement section 148 performs mapping of attribute information about arranged landscape architectural elements and related image information in location storage 148-4, and sizes of the landscape architectural elements thusly mapped are scaled down by a scale processing component 148-2 to the same scale as the landscape site.

The display processing unit 150 loads real images from the database based on information on the landscape architectural elements arranged on the plan view according to the user's selected locations through the user interface 110, and performs the necessary processing to make the real images to be displayed through the user interface 110.

To this end, the display processing section 150 is constituted by a photographing location processing section 152, a photographing date processing section 154, a photographing period processing section 156, and a landscape architecture management information processing section 158.

More specifically, the photographing location processing section 152 replaces the respective landscape architectural elements arranged at the user's selected locations on the plan view with real images that are photographed at the selected locations, and displays the photographed real images. That is, as aforementioned, the database 130 stores real images of the landscape architectural elements photographed in diverse angles and directions, and the photographing location processing section 152 performs the necessary processing to produce real images, photographed at the user's selected angles and directions.

In addition, the photographing date processing section 154 replaces the landscape architectural elements with real images photographed on the selected date from the database 130 once the user selects the photographing date through the user interface 110.

When the photographing period set-up is added through the user interface 110, the photographing period processing section 156 loads from the database 130 all the real images photographed during the set-up period by dates/weeks/months, and displays them sequentially. In this manner, the user can easily see the changes in the landscape architectural elements during the change of season, and see the entire landscape architecture during the period once specific date or week of the year is designated.

Meanwhile, the information in the database 130 may be collated by the information generating unit 160 and processed in the landscape architecture management information processing section 158. Here, the information generating unit 160 produces useful information for landscape architecture planning. To this end, the information generating unit 160 is comprised of a specification generating section 160-2 and an estimated budget generating section 160-4.

The specification generating section 160-2 generates, in response to a specification information generating command entered through the user interface 110, specification information based on the location information of landscape architectural elements stored in the location storage 148-4. In addition, the estimated budget generating section 162 generates, in response to an estimated budget generating command entered through the user interface 110, an estimated budget based on the price information about landscape architectural elements stored in the location storage 148-2. The information thusly generated are displayed through the user interface 110 for later use.

Moreover, the system may further include an authentication unit (not shown) for comparing and authenticating the necessary items, such as location of the landscape site, any legal restrictions, weather conditions, geographical conditions and the like entered through the user interface 110 and the particulars desired by the landscape architecture designing requester with the arranged landscape architecture.

### MODE FOR THE INVENTION

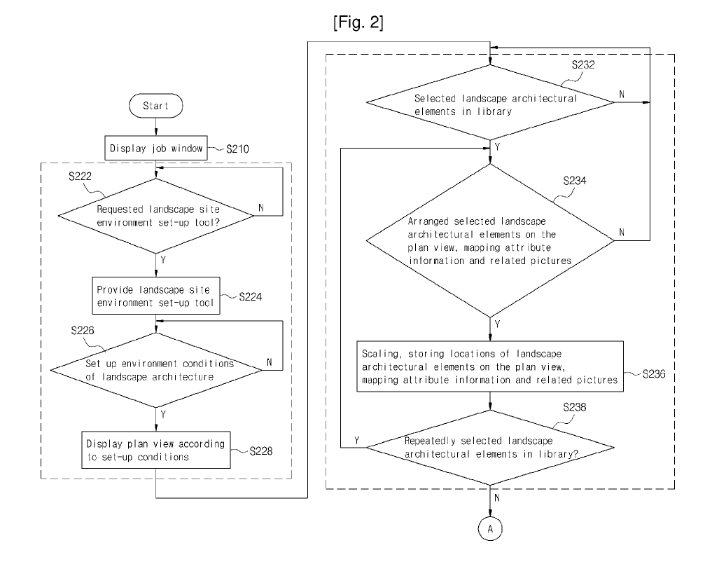

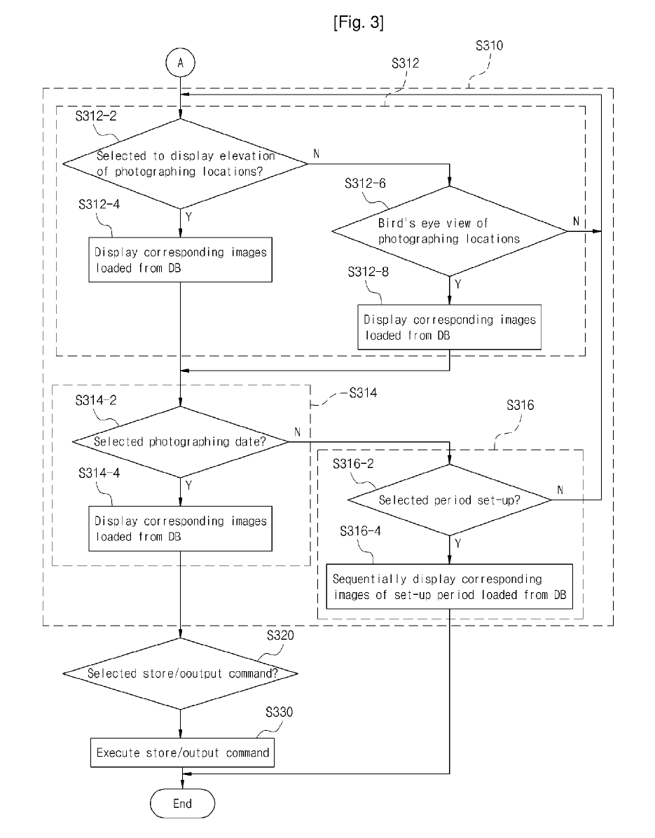

FIG. 2 and FIG. 3 are flow charts describing one embodiment of the operation of the system in FIG. 1.

When the user starts using the system, the input processing unit 140 displays a job engine showing a job space where the user designs landscape architecture S210. That is, the job engine is an application engine for designing landscape architecture, and includes a menu bar, tool bar and a library window. The menu bar contains many basic commands, such as, File, Edit, View, and Help menus, for the user to select. The tool bar contains commands the user needs to actually design landscape architecture. The library window allows the user to select landscape architectural elements.

Later, the input processing unit 140 generates and displays a plan view according to the set-up environment of the landscape architecture entered through the user interface S220. Namely, when the user requests a suggestion from the environment condition set-up tool S222, the landscape architecture environment processing section 142 offers a landscape site environment set-up engine S224 to allow the user to set up the environment of the landscape site through this landscape site environment set-up engine S226. In response to this set-up, the landscape architecture environment processing section 142 prepares a plan view of the entire landscape site, a plan view of building(s), and a contour line showing elevation levels of the site.

In addition, the user may input all necessary items including location of the landscape site, any legal restrictions, weather conditions, geographical conditions and the like through the landscape site environment set-up engine. Also, the user may input the particulars desired by the landscape architecture designing requester through the landscape site set-up engine. In such cases, the necessary items and the particulars desired by the landscape architecture designing requester can be compared and authenticated with the arranged landscape architecture.

Next, the input processing unit 140 arranges real images of the landscape architectural elements from the database 130, which the user selected through the library window, on the plan view S230. At this point, the landscape architectural element selection processing section 144 checks whether the user has selected landscape architectural elements in the library S232 and whether the selected landscape architectural elements are arranged on the plan view S236. The arranging section 148 scales down the size of the real images of the selected landscape architectural elements to the same scale as the plan view, and performs mapping of specific information and related photographs of the selected landscape architectural elements S236. In other words, the size of the selected landscape architectural elements is scaled down to the same scale in the job engine by the scale processing component 148-2, and the locations of the scale-adjusted landscape architectural images are stored in the location storage 148-4.

The library window of the input processing unit 140 includes many of search engines searching the landscape architectural elements, which are categorized by diverse attributes thereof, such as, conifers/non-coniferous, blooming period, colors of flowers, weather appropriateness, etc. For example, when the user selects the blooming period category on the search engine, all available landscape architectural elements blooming in that particular period are listed, and the user conveniently selects appropriate ones among the listed landscape architectural elements.

Next, when the user selects and arranges the landscape architectural elements repeatedly or when the user selects different landscape architectural elements and changes the locations thereof S238, the system returns to a status that allows the user to arrange the landscape architectural elements he selects S234. In this way, the user is able to replace and arrange landscape architectural elements, or change locations of the selected, arranged landscape architectural elements.

As explained before, after the arrangement of landscape architectural elements onto the plan view, the display processing unit 150 supports the user to confirm the landscape architectural images, which are designed according to the photographing locations the user selected, with real images S310.

That is, the display processing unit 150 replaces the landscape architectural elements arranged on the plan view according to the user's selected photographing locations with real images photographed at the selected photographing locations, and displays the real images S312. For instance, when the user selects the photographing locations by elevation S312-2, the photographing location processing section 152 loads from the database 130 the real images photographed from the front, and displays them in S312-4. The elevation shows how water tubes of plants are connected to each other when the landscape plants were photographed right in front.

Similarly, when the user selects photographing locations from a bird's eye view S312-6, the display processing unit 150 loads real images from this perspective and displays them S312-8. Here, the bird's eye view is an image taken from the air. In detail, the display processing unit 150 displays the landscape site inclined at about 27 degrees on the plan view, and displays the perspective pictures of the landscape architectural elements as real images. To make the images look more realistic, in case of the elevation and the bird's eye view, sizes of the trees in the back are adjusted to look smaller than the trees in the front.

When the user selects a specific photographing date S314-2, the photographing date processing section 154 loads from the database 130 real images of the landscape architectural elements arranged on the plan view, which are taken on the selected date, and displays the photos at corresponding locations in replacement of the landscape architectural elements S314-4.

In addition, when the user selects a specific photographing period S316-2, the photographing period processing section 156 sequentially loads from the database 130 real images of the landscape architectural elements arranged on the plan view, which are taken on the selected period, and displays the photos at corresponding locations in placement of the landscape architectural elements S316-4. In general, the period can be selected by the unit of day, week and/or month, and through the sequential display, the user can see the growth simulation of plants according to the change in time period.

When the user wants to modify or retouch the displayed design, the system returns to the selection and arrangement stage of the landscape architectural elements and changing locations thereof S230.

When the landscape architectural design is completed, the user selects a store/output command S320. Then, the input/output command processing section 146 stores/outputs a plan view, an elevation and a bird's eye view.

In the meantime, in response to a user command, the system is capable of generating know-how or instructions in managing the selected plants. Moreover, the system can provide an estimate that shows an expense budget for purchasing and delivering the selected landscape architectural elements, labor costs for planting them, etc. Furthermore, the system can prepare a report that details appropriate construction time, selection of materials, procedure, method, know-how and problems to avoid in transplanting.

In particular, if landscape architecture contractors provide real image data of the respective landscape architectural elements via a web server, the user is able to search the real image data of desired landscape architecture elements through the landscape architecture contractor's server. Such image data can be used for designing or updating the existing database. In case the Internet is connected, the present invention system also makes it possible to order and sale the landscape architectural elements at a time.

As explained so far, the present invention system provides a database of real images of landscape architectural elements in their natural colors, so that the user can easily design realistic landscape architecture simply by arranging the real images that correspond to landscape architectural elements of interest on a plan view of the landscape site. Thus, even non-experts can easily design landscape architecture based on real images.

Since the database stores real images of the landscape architectural images by the unit of day, month and season, the present invention system can provide the user with a growth simulation of the landscape architectural elements according to the time variant changes. Therefore, compared with existing landscape architecture design methods, the present invention system is markedly more efficient and cost-effective.

In addition, since the database storing natural color images of plants makes it possible to provide a growth simulation that is more realistic (showing plant growth in time) than in books, magazines, etc., it can be advantageously used for educational and academic purposes.

Although the preferred embodiment of the present invention has been described, it will be understood by those skilled in the art that the present invention should not be limited to the described preferred embodiment, but various changes and modifications can be made within the spirit and scope of the present invention as defined by the appended claims.

1. A system for designing landscape architecture based on real images, comprising:
a user interface supporting an exchange of information between a user and the system;
a database storing real images obtained by processing photographs of landscape architectural elements;
an input processing unit processing data to display a plan view according to a set-up environment of a landscape site entered through the user interface, and processing data to arrange on the plan view real images of landscape architectural elements which are selected through a library window provided, based on the database; and
a display processing unit loading real images from the database based on information about the landscape architectural elements arranged on the plan view according to the user's selected locations entered through the user interface, and displaying the real images.

2. The system of claim 1, wherein the database stores real images of the landscape architectural elements photographed in diverse angles and directions, and wherein the display processing unit comprises a photographing location processing section which loads from the database real images of the landscape architectural elements in correspondence to the user's selected direction and angle entered through the user interface and which displays the real images.

3. The system of claim 1, wherein the database stores real images of the landscape architectural elements photographed according to a predetermined period, wherein the landscape architectural elements comprise real images of landscape plants photographed over time, and
wherein the display processing unit comprises a photographing date processing section which replaces the landscape architectural elements with real images photographed on a selected photographing period entered through the user interface and which displays the real images.

4. The system of claim 3, wherein the user interface provides a menu comprising a photographing period of the landscape plants being subdivided into at least one of days, weeks, months, and seasons, and wherein the display processing unit comprises a photographing period processing section which displays real images photographed during the selected photographing period entered through the user interface.

5. The system of claim 1, wherein the input processing unit comprises:
a location storage storing information about locations of landscape architectural elements arranged in the landscape site; and
a scale processing part scaling down the landscape architectural elements arranged on the plan view to the scale on the landscape site display.

6. The system of claim 1, wherein the library window comprises search engines through which the landscape architectural elements are searched from the database according to the categories given by attributes of the landscape architectural elements, and which selectively lists the landscape architectural elements corresponding to a category selected by the user.

7. A database for use in a system for designing landscape architecture based on computer-readable real images, the database storing:
real images of landscape architectural element photographs without a background; and
at least one piece of information selected from the group consisting of names, attributes, management methods and prices of the respective landscape architectural elements.

8. A method for designing landscape architecture based on real images comprising:
displaying through a user interface a plan view of a set-up environment of a landscape site;
processing data to arrange on the plan view real images of selected landscape architectural elements entered by a user through the user interface, wherein the landscape architectural elements are selected by the user from a library provided to the user based on elements in a database storing real images obtained by processing photographs of the landscape architectural elements; and
after the user selects photographing locations through the user interface, displaying through the user interface real images of photographed landscape architectural elements stored in the database corresponding to the selected landscape architectural elements at the photographing locations selected by the user.

9. The method of claim 8, wherein the database stores real images of the landscape architectural elements photographed according to a predetermined period,
the method further comprising:
after the user selects a photographing period through the user interface, displaying through the user interface real images of photographed landscape architectural elements stored in the data base corresponding to the selected landscape architectural elements for the photographing period selected by the user.

10. The method of claim 9, wherein the user interface provides a menu comprising photographing period being subdivided into at least one of days, weeks, months, and seasons,
the method further comprising:
sequentially displaying real images photographed during the user's selected photographing period entered through the user interface.

11. The method of claim 8, wherein the database stores real images of the landscape architectural elements photographed in diverse angles and directions, and wherein the displaying the real images displays real images of the landscape architectural elements photographed from an angle and direction selected by the user.

12. The method of claim 8, wherein the database stores management instructions for the respective landscape architectural elements, and wherein the management instructions are displayed if a user requests through the user interface to display the management instructions of the respective landscape architectural elements.

13. The method of claim 8, wherein the processing of the data involves adjusting scales of the landscape architectural elements arranged on the plan view to fit the scale on the display of the landscape site.

14. The method of claim 8, further comprising:
generating, in response to a command for generating a landscape architecture specification entered through the user interface, the landscape architecture specification based on information about the selected landscape architectural elements; and
generating, in response to a command for generating an estimated budget information entered through the user interface, the estimated budget information based on information about the selected landscape architectural elements.
